(19) United States
(12) Patent Application Publication
(10) Pub. No.: US 2012/0005466 A1
(43) Pub. Date: Jan. 5, 2012

(54) DATA PROCESSING DEVICE AND METHOD FOR OPERATING SUCH DATA PROCESSING DEVICE

(75) Inventors: Mathias Wagner, Alvensen-Rosengarten (DE); Feuser Markus, Hamburg (DE)

(73) Assignee: KONINKLIJKE PHILIPS ELECTRONICS N.V., Eindhoven (NL)

(21) Appl. No.: 11/722,349

(22) PCT Filed: Dec. 12, 2005
(86) PCT No.: PCT/IB2005/054179

§ 371 Date: Nov. 17, 2009

(30) Foreign Application Priority Data
Dec. 20, 2004 (EP) 04106722.4

(51) Int. Cl. H04L 9/00; G06F 9/00

(52) U.S. Cl. 713/2; 713/189

(57) ABSTRACT

In order to provide a data processing device (100), in particular an embedded system, such as a smart card, comprising at least one integrated circuit (102) carrying out calculations, in particular cryptographic operations, as well as a method for operating such data processing device (100) wherein costs are minimised, the requirements on the complexity of the design are decreased, the power consumption is reduced and the performance of a cryptographic operation is enhanced, it is proposed to protect the integrated circuit (102) against cryptanalysis, in particular against differential power analysis, by hiding the power consumption profiles of said calculations and by alternating between different power consumption profiles, in particular by introducing one or more counter signals (51; 61; 71, 81), for example one or more signals of at least roughly opposite amplitude relative to an average amplitude, wherein the sum of the respective amplitude of the one or more original or true signals (50; 60; 70, 80) may be at least roughly balanced out by the sum of the respective amplitude of the one or more counter signals (51; 61; 71, 81) and/or wherein the number of original or true signals (50; 60; 70, 80) is not necessarily equal to the number of counter signals (51; 61; 71, 81), with for example two counter signals (51; 61; 71, 81) on average for every original or true signal (50; 60; 70, 80).

The present invention relates in general to the technical field of impeding cryptanalysis, in particular differential power analysis.

Specifically, the present invention relates to a data processing device, in particular to an embedded system, such as a smart card, comprising at least one integrated circuit carrying out calculations, in particular cryptographic operations, as well as to a method for operating such data processing device.

Embedded systems, such as for example smart cards, are often used in areas where security issues are of concern. Cryptographic operations are used to establish authentication between the embedded system and a host, which typically involves the usage of a secret key in a cryptographic protocol to prove one's identity to the other side.

In the background state of the art (cf. for instance prior art documents U.S. Pat. No. 6,419,159 B1, U.S. Pat. No. 6,625,737 B1, U.S. Pat. No. 6,654,884 B2, WO 99/63696 A1, WO 99/67766 A2, WO 99/67919 A2, WO 00/19366 A1, WO 00/19367 A1, WO 00/19385 A1, WO 00/19386 A1, WO 00/19608 A2, WO 00/26746 A2, WO 00/26868 A1, WO 00/70761 A1, and WO 01/93192 1A, as well as references therein) it is known that physical embodiments of cryptographic operations are potentially susceptible to attacks such as the D[ifferential]P[ower]A[nalysis] where minute differences in the power consumption when processing the secret key are used to retrieve this secret key or parts thereof, thereby eventually obtaining unauthorised access to privileged data and information stored on the embedded device. Such an attack usually requires repeated power consumption measurements to improve the S[ignal to]N[oise]R[atio], and a measure for the resilience of a device against these attacks is the number of measurements, i. e. the number of “power traces” required to recover the secret key.

In the background art is has been appreciated that countermeasures can be implemented on the basis of
shared secrets (so-called “blinding” of data),
the usage of “unpredictable information” as a source of randomness to reduce the S[ignal to]N[oise]R[atio], as well as
an updating procedure for the secret key on the basis of a blinding factor

(cf. prior art document WO 99/67919 A2).

In prior art document WO 99/63696 A1 yet another approach has been put forward where additional random noise, generated in the device, is used to deteriorate the S[ignal to]N[oise]R[atio].

Alternatively, random clock skipping may be used to impede the analysis by hiding the relevant portions of the power consumption trace along the time axis.

Also, a random ordering of the cryptographic events has been discussed as a means to obfuscate a D[ifferential]P[ower]A[nalysis].

By suitably transforming the binary representation of data and algorithms (for example by using a dual-rail logic implementation where one logical bit corresponds to two physical bits) in conjunction with a “circuit matching” approach, a “constant Hamming weight representation” can be achieved, which again is less susceptible to such an attack (cf. prior art documents WO 99/67766 A2, U.S. Pat. No. 6,654,884 B2 and U.S. Pat. No. 4,563,546).

All these approaches generally do not aim at making a D[ifferential]P[ower]A[nalysis] impossible, but rather render it impractical in the sense that the costs and time involved with such an attack become prohibitively high.

In other words, known methods for addressing the problem of differential power analysis have the disadvantages
of a much increased power consumption (for instance for the dual-rail logic implementation) and/or
of increased requirements on the complexity of the design (for instance for the dual-rail logic implementation or for the shared secret approach),

which translates into the physical size of a design and hence into costs.

Some methods reduce the performance of a cryptographic operation by slowing it down.

Also, an essential ingredience of known methods is the employment of a random number generator as a means to generate randomness, which is notoriously difficult to design and verify.

All these disadvantages of known methods are of particular concern in embedded systems such as smart cards, where cost minimisation is imperative.

Starting from the disadvantages and shortcomings as described above and taking the prior art as discussed into account, an object of the present invention is to further develop a data processing device as detailed in the preamble of claim 1 as well as a method as detailed in the preamble of claim 5 in such way that costs are minimised, the requirements on the complexity of the design are decreased, the power consumption is reduced and the performance of a cryptographic operation is enhanced.

The object of the present invention is achieved by a data processing device comprising the features of claim 1 as well as by an operating method comprising the features of claim 5. Advantageous embodiments and expedient improvements of the present invention are disclosed in the respective dependent claims.

The present invention relates in general to a data processing device, in particular to an embedded system, such as a smart card, as well as to an operating method for operating such data processing device in a way by which differential power analysis is impeded.

The device comprises at least one integrated circuit which carries out useful calculations, in particular cryptographic operations, in accordance with the principle of anti-sound so as to hide power consumption profiles of said operations. To this end, the present invention provides a method to alternate between different power consumption profiles where said method is driven by a periodic signal.

In the present invention, the use of the principle of anti-sound as a means to generate obfuscating signals impeding differential power analysis is proposed. As known in the prior art, the differential power analysis draws its strength from tiny differences in the power consumption when cryptographic calculations are being performed.

The underlying assumption is that the same cryptographic calculation will always generate the same tiny difference, so that an average over many similar cryptographic operations will result in a net signal clearly above the noise level.

What has not been appreciated in the prior art, however, is that it is possible to actively modify the power consumption profile on a hardware level so as to introduce signals of roughly opposite amplitude (relative to an average amplitude) deliberately, which will virtually wipe out the original (or true) signals when an average over all power traces is taken. In this context, actively modifying the signals by deliberately introducing tailored counter signals is a much more effective approach than merely adding random noise.

The approach to balance Hamming weights as described in the prior art (for example in the form of a dual-rail logic) does this in a time-simultaneous fashion, i. e. by trying to minimise the leakage at each point in time simultaneously, and for each power trace separately.

However, this degree of leakage reduction is not required, as an essential step in a differential power analysis is the averaging over many power traces. Hence, although each and every power trace by itself may be leaky, the average over many power traces does not necessarily have to be leaky, provided for each leaky signal there is a signal of roughly opposite amplitude that counteracts the effect of the first signal.

According to an expedient embodiment of the present invention the counteracting signal does not have to be generated during the same cryptographic calculation as the first signal (although it may), and thus may occur in a different power trace altogether. For this to work it is helpful that a potential adversary does not know at what time a signal has been inverted, and when not.

In principle, at least one random number generator can be used to this end, but according to a preferred embodiment of the present invention it is quite enough to implement at least one finite state machine; in this context, the usage of the relatively small finite state machine is advantageous over the usage of a random number generator. By using such finite state machine with a fixed cycle length, preferably prime, or any other suitable periodical unit, the order of signals and of counter signals can be controlled in an expedient manner.

By the advantageous use of such periodic logic unit with a cycle length being preferably a prime number, no correlations are expected with trial cycle lengths assumed by an attacker as such trial cycle length cannot be accidentally an integer fraction of the actual cycle length in this case.

According to an expedient but not obligatory embodiment of the present invention at least one non-volatile memory can be provided to store information on at least one suitable state, such as for example on the last state or on the current state, of the finite state machine or periodical unit. As a consequence, after a (possibly forced) reset of the device the finite state machine will not necessarily start at the beginning of the finite state cycle all the time by using the information stored in the non-volatile memory as a seed; this option will reduce the effectiveness of a differential power analysis further.

In other words, according to a particularly inventive refinement of the present invention it is beneficial, although not required that the device keeps the non-volatile memory of the suitable state in the finite state machine or periodical unit at power down so that the state after powering up the device will not be the same all the time, as this would perhaps facilitate a differential power analysis.

Alternatively, the finite state machine or periodical unit can be seeded at power up. Due to the fact that according to the present invention the counter signals can be produced during different cryptographic calculations and not necessarily instantaneously at the moment of the original, leaky signal, power consumption as well as chip area are much reduced compared to the prior art.

According to another preferred embodiment of the present invention at least one sensor of physical characteristics can be used to provide at least one seed value for the finite state machine. To this end, the output of at least one temperature sensor can be converted to at least one binary seed number using at least one A[nalog]/D[igital] converter.

Since temperature drifts are very normal when operating an electronic device (and in fact constitute one of the problems to be overcome by an attacker trying to launch a differential power analysis) one can expect a reasonable distribution of seed values for the finite state machine for all but the most stringently controlled operating environments.

According to a preferred embodiment of the present invention the balancing of signals may be done in such way that more than one counter signal is required to compensate the original or true signal. In this case, only the sum of the amplitudes of signals has to be roughly balanced by the sum of the amplitudes of counter signals.

The present invention finally relates to the use of at least one data processing device as described above and/or of the method as described above for protecting digital parts of at least one integrated circuit, in particular for increasing the security of at least one integrated circuit against unauthorized access, for example via cryptanalysis, in particular via differential power analysis

The techniques described in the present invention are not limited to smart cards but apply to all embedded devices and in fact to all cryptographic devices where physical quantities may be measured to perform a differential cryptographic “power” analysis as a means to extract secrets stored in that device, where the physical quantity analysed may even be something else than power consumption, for example electromagnetic radiation.

In particular, the techniques described in the present invention apply to hardware implementations of the D[ata]E[ncryption]S[tandard] algorithms and A[dvanced]E[ncryption]S[tandard] algorithms, as well as implementations of R[ivest,]S[hamir and]A[dleman] and E[lliptic]C[urve]C[ryptosystem].

As already discussed above, there are several options to embody as well as to improve the teaching of the present invention in an advantageous manner. To this aim, reference is made to the claims respectively dependent on claim 1 and on claim 5; further improvements, features and advantages of the present invention are explained below in more detail with reference to a preferred embodiment by way of example and to the accompanying drawings where

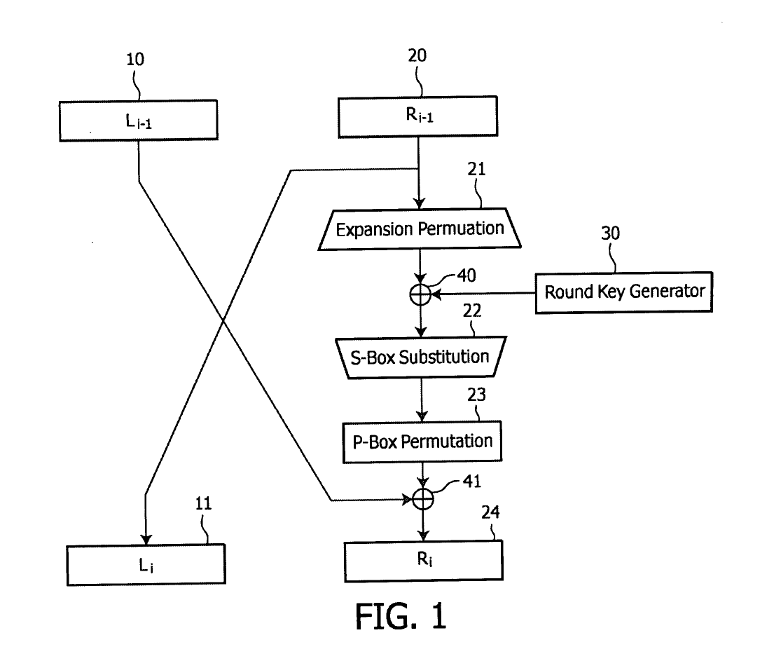

FIG. 1 schematically shows an embodiment of a cycle of a D[ata]E[ncryption]S[tandard] algorithm as used in the present invention;

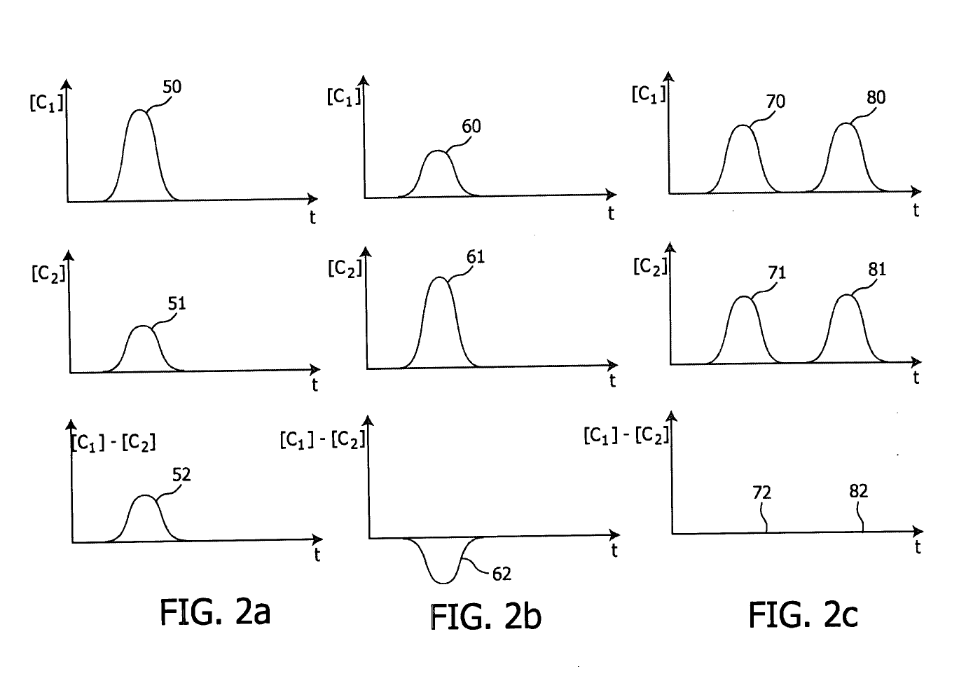

FIG. 2a schematically shows a respective diagram of the signal of the average <C₁> of the first class C₁, of the signal of the average <C₂> of the second class C₂, and of the signal of the correlation function D=<C₁>-<C₂>, each plotted versus the time;

FIG. 2b schematically shows a respective diagram of the inverted signal of the average <Cᵢ> of the first class C₁, of the inverted signal of the average <C₂> of the second class C₂, and of the inverted signal of the correlation function D=<C₁>-<C₂>, each plotted versus the time;

FIG. 2c schematically shows a respective diagram of the mixed-up signal of the average <C₁> of the first class C₁, of the mixed-up signal of the average <C₂> of the second class C₂, and of the mixed-up signal of the correlation function D=<C₁>-<C₂>, each plotted versus the time; and

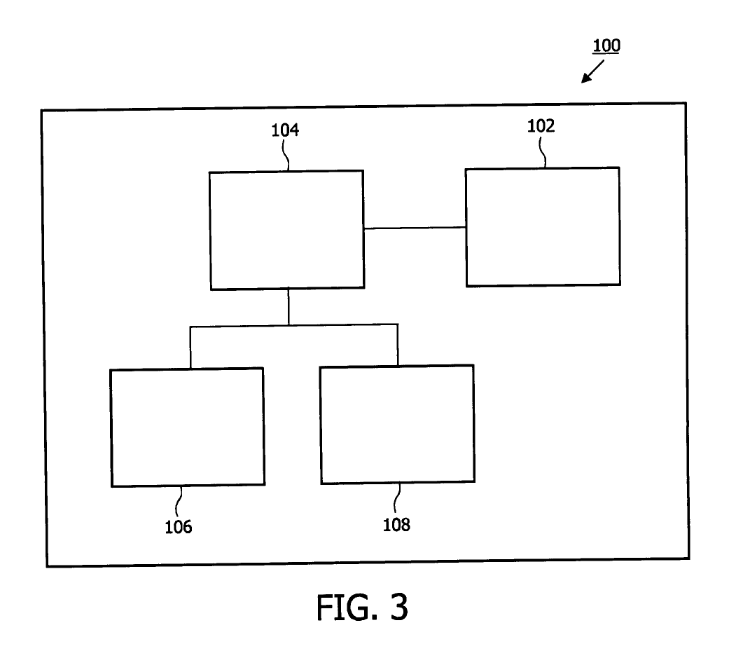

FIG. 3 schematically shows an embodiment of a data processing device according to the present invention, this data processing device being operated according to the operating method of the present invention.

The same reference numerals are used for corresponding parts in FIGS. 1 to 3.

The preferred embodiments disclosed hereafter refer to the D[ata]E[ncryption]S[tandard] algorithm but those skilled in the art will appreciate that the techniques described apply to other cryptographic algorithms as well such as, but not limited to, the A[dvanced]E[ncryption]S[tandard] algorithm, the R[ivest,]S[hamir and]A[dleman] algorithm, the E[lliptic]C[urve]C[ryptosystem] algorithm, and the S[ecure]H[ash]A[lgorithm]1 algorithm.

The DES algorithm belongs to the group of Feistel algorithms with sixteen rounds. One of these rounds is schematically illustrated in FIG. 1 (and further details can be found in chapter 12 of “Applied Cryptography” by Bruce Schneier).

In more detail, FIG. 1 shows the internal structure of the function of such DES algorithm round: the 64 bit key supplied to DES is first reduced to 56 bits by ignoring every eighth bit. After the 56 bits have been extracted, a 48 bit subkey is generated in the round key generator 30 for each of the sixteen rounds in DES. This generation of the 48 bit subkey is done by first dividing the 56 bit key into two halves, then shifting each half circularly by one or two bits, depending on the round.

After shifting, 48 bits of the 56 bits are selected. This is called a compression permutation because this selection provides a scrambled subset of the original 56 bits. Because of this shifting, a different subset of the original key's bits is used in each of the subkeys used in a given round.

In addition, an extra logic is provided within the round key generator 30 in order to provide inverted keys suitable for reducing the S[ignal to]N[oise]R[atio] for a certain range of select functions.

In the expansion permutation 21, the right half of the data Rᵢ₋₁ is expanded from 32 bits to 48 bits. These 48 bits are expanded by repeating certain bits and some of the bits are rearranged as well because it is a permutation. The main purpose of the expansion permutation 21 is to make the right half of the data Rᵢ₋₁ the same size, namely 48 bits as the key provided by the round key generator 30 because both pieces of data will be exclusive-ORed.

In this context, the first XOR logic component is represented by reference numeral 40 in the next step. The expansion permutation 21 is important for two reasons:
first, since the expansion permutation 21 repeats certain bits, the expansion permutation 21 allows each repeated bit to affect more than one substitution, so the dependency of the output bits on the input bits spreads faster (this is called the avalanche effect, and is one of the main goals in cryptography); and
the second important effect is that although the expansion permutation 21 takes in a 32 bit string and outputs a 48 bit string, every 32 bit string generates exactly one 48 bit string, i. e. there is no 48 bit string which can be generated by two different 32 bit strings. This is important because otherwise, when trying to decrypt the data, it would not be known for sure which 32 bit string the 48 bits came from.

The output of the expansion permutation 21 and the output of the compression permutation are then XORed by means of the first XOR logic component 40. The 48 bit result of this XOR operation is then passed through an S-box substitution function 22. The S-box substitution 22 takes six bits from the 48 bit result as input, and outputs four bits. There are eight S-boxes, so all 48 bits of the input are consumed. Each S-box is a table of four rows and sixteen columns:

Each (row,column) pair in a table is a four bit number to output. The six input bits specify the row and column values to look at for the four bit output. Bit no. 1 and bit no. 6 of the input are combined to form a two bit number whose base-10 value is between 0 and 3. This is used to specify the row to use look in for the S-box. Bit no. 2, bit no. 3, bit no. 4 and bit no. 5 are combined to form a four bit number whose base-10 value is between 0 and 15, and corresponds to the row to use.

After the S-box substitution 22 outputs its 32 bits, the P-box permutation 23 comes; this P-box permutation 23 is a straightforward permutation of bits. The results of the P-box permutation 23 are XORed by means of a second XOR logic 41 with the left half Lᵢ₋₁ of the initial 64 bit block (cf. reference numeral 10). The left half and the right half switch position, and another round begins.

After all sixteen rounds are over, the output goes through a final permutation, which is the inverse of the initial permutation. The reason for having such final permutation is that the same algorithm can be used to encrypt and to decrypt messages.

One possible so-called select function to be used in a differential power analysis relates to the updating of the R register 20 in the first round or in the last round of the DES algorithm to obtain a new value as a function of the input data in this R register 20 and the round key as generated in a round key generator 30.

The idea behind this is that in C[omplementary-symmetry]M[etal]O[xide]S[emiconductor] technology the transition of a register bit from 0 to 1 or from 1 to 0 consumes a different amount of power than the other two cases, 0 to 0 and 1 to 1, where no such transition takes place. As described for instance at the internet site http://www.cryptography.com an attacker would typically create two classes C₁ and C₂ of power traces:
a first class C₁ where the select function—on the basis of a hypothesis about a small part of the secret round key—indicates that a target bit of the R register 20 under investigation has changed its state; and
a second class C₂ where the target bit did not change its state.

With respect to the first class C₁ where the target bit of the R register 20 makes a transition said R register 20 gets updated from the data Rᵢ₋₁ register (cf. reference numeral 20) via a reference to block Lᵢ₋₁ (cf. reference numeral 11), an expansion permuation 21, a first point (=first XOR logic 40), an S-box substitution 22, a P-box permutation 23 and a second point 41 (reference from block Lᵢ; cf. reference numeral 10) to the data Rᵢ register (cf. reference numeral 24).

Once all power traces have been classified according to this select function, the difference D=<C₁>-<C₂> of the averages <C₁>, <C₂> of these two classes C₁, C₂ is taken and analysed (cf. FIG. 2a for details). A significant peak 52 in this correlation function D=<C₁>-<C₂> (=difference between the signal peak 50 of the average <C₁> of the first class C₁ and the signal peak 51 of the average <C₂> of the second class C₂) would indicate that the hypothesis underlying the select function was correct, and hence the corresponding part of the secret round key correctly guessed.

Now, if the round key fed into the algorithm at the first point 40 of FIG. 1 is bit-wise inverted, the two classes C₁, C₂ of power traces exchange their roles under the very same hypothesis and select function as above. What used to be the class containing all power traces where a transition of the target bit in question appeared to have occurred (according to the underlying hypothesis) will now be the class where no such transition took place, and vice versa.

Consequently, the differential correlation function D=<C₁>-<C₂> (=difference between the signal peak 60 of the average <C₁> of the first class C₁ and the signal peak 61 of the average <C₂> of the second class C₂) discussed above would exhibit a peak 62 of opposite amplitude compared to FIG. 2a (cf. FIG. 2b for details).

Therefore, when the design of the underlying hardware is such that in for example fifty percent of all cases the bit-wise inverse of the round key is used instead of the correct round key, then the two classes C₁, C₂ of power traces will be perfectly mixed up, on average, and no useful correlation signal 72 and 82 (=difference between the signal peaks 70, 80 of the average <C₁> of the first class C₁ and the signal peaks 71, 81 of the average <C₂> of the second class C₂; cf. FIG. 2c for details) will be found at all.

In this context, it has to be taken into consideration that in fifty percent of all calculations the cryptographic result will be wrong, as the wrong secret round key has been used. But this can be simply corrected by requiring that the crypto engine performs each calculation twice (cf. FIG. 2c), once with the correct round key and the other time with the bit-wise inverted round key, but ignoring the result of the latter.

If the order of these two calculations gets suitably changed from one DES calculation to the next, then the anti-sound like averaging effect still continues to work. The decision when and how often to swap the order needs to be taken by at least one logic unit such that the ordering is balanced as perfectly as possible when averaging over many power traces.

For such balanced ordering it is not required to use a random number generator, as a finite state machine or any other periodic unit is completely adequate as long as the fifty percent rule is adhered to. Deviations from the fifty percent rule will result in a reduced effectiveness of the countermeasure.

On the other hand, there exist target bits and select functions other than the one just described, each of which usually prescribing a different partition of unity for the power traces, and thus it becomes necessary to analyse a range of possible other attacks as well and to find a way to swap the resulting two classes C₁, C₂ of power traces for each such attack. Achieving perfect balancing simultaneously in all these cases will in general not be possible, and as a consequence one has to find a compromise that protects against all attacks equally well.

In this context, it may be appreciated that it is not required that two individual signals balance each other perfectly. The present invention works equally well when only the sum over two or more signals gets balanced out by the sum over two or more counter signals.

Similarly, the fifty percent rule may be modified by allowing other ratios of true signals to counter signals, for example two counter signals on average for every true signal.

A preferred embodiment of the present invention is based on the usage of the anti-sound principle as described above. First of all, in addition to FIG. 1 at least one controlling part is provided monitoring the compliance with the fifty percent rule. Furthermore, at least one extra logic is provided within the round key generator 30 in order to provide inverted keys suitable for reducing the S[ignal to]N[oise]R[atio] for a certain range of select functions.

According to the exemplary implementation of the present invention in FIG. 3, the data processing device 100 in the form of a smart card (=embedded system) comprises an I[ntegrated]C[ircuit] 102 carrying out cryptographic calculations as well as cryptographic operations.

This integrated circuit 102 is protected against cryptanalysis, in particular against differential power analysis,
by hiding the power consumption profiles of said calculations and operations as well as
by alternating between different power consumption profiles.

This hiding as well as alternating is done by introducing the counter signals 51 (cf. FIG. 2a), 61 (cf. FIG. 2b), 71, 81 (cf. FIG. 2c) in the form signals having an opposite amplitude relative to an average amplitude.

In FIG. 3, a finite state machine 104 (or any other periodical unit) is assigned to the integrated circuit 102 so as to control the order of the original or true signals 50 (cf. FIG. 2a), 60 (cf. FIG. 2b), 70, 80 (cf. FIG. 2c) and of introduced counter signals 51 (cf. FIG. 2a), 61 (cf. FIG. 2b), 71, 81 (cf. FIG. 2c).

In addition, a non-volatile memory 106 for storing information on a suitable state, for example on the last state or on the current state, of the finite state machine 104 is assigned to the finite state machine 104 and thus to the integrated circuit 102; this non-volatile memory 106 of the suitable state of the finite state machine 104
can be kept at power down so that the state after powering up the data processing device 100 is not the same all the time or
the finite state machine 104 can be seeded at power up.

As can be further taken from FIG. 3, a sensor unit 108 of physical characteristics, such as the ambient temperature, for providing the seed value for the finite state machine 104 may be assigned to the finite state machine 104 and thus to the integrated circuit 102.

Other sensors that could be used to generate seed values are sensors for the internal supply voltage or for the external supply voltage, clock sensors, or sensors monitoring the activity on the I[nput]O[utput] channel.

The data processing device 100 as well as the method of operating said data processing device 100 described above apply to cryptographic calculations as well as to cryptographic operations conforming to the D[ata]E[ncryption]S[tandard] in particular. Apart from that, this method can be adapted in a suitable fashion for A[dvanced]E[ncryption]S[tandard], R[ivest,]S[hamir and]A[dleman], E[lliptic]C[urve]C[ryptosystem] etc. where simple key inversions as described above will not necessarily work.

### LIST OF REFERENCE NUMERALS

100 data processing device, in particular embedded system, such as smart card

102 integrated circuit

104 finite state machine or periodical unit

106 non-volatile memory unit

108 sensor unit

10 left half Lᵢ₋₁ of the initial 64 bit block

11 left half Lᵢ of the initial 64 bit block

20 Rᵢ₋₁ register

21 expansion permuation

22 S-box substitution, in particular S-box substitution function

23 P-box permutation

24 Rᵢ register

30 round key generator with at least one logic component

40 first point, in particular first XOR logic component

41 second point, in particular second XOR logic component

50 signal, in particular peak, of average <C₁> of first class C₁

51 signal, in particular peak, of average <C₂> of second class C₂

52 signal, in particular peak, of correlation function D

60 inverted signal, in particular inverted peak, of average <C₁> of first class C₁

61 inverted signal, in particular inverted peak, of average <C₂> of second class C₂

62 inverted signal, in particular inverted peak, of correlation function D

70 first signal, in particular first peak, of average <C₁> of first class C₁

71 first signal, in particular first peak, of average <C₂> of second class C₂

72 first signal of correlation function D

80 second signal, in particular second peak, of average <C₁> of first class C₁

81 second signal, in particular second peak, of average <C₂> of second class C₂

82 second signal of correlation function D

C₁ first class

<C₁> average of first class C₁

C₂ second class

<C₂> average of second class C₂

D correlation function (=difference between average <C₁> and average <C₂>)

t time

1. A data processing device (100), in particular an embedded system, such as a smart card, comprising at least one integrated circuit (102) carrying out calculations, in particular cryptographic operations,
characterized by
protecting the integrated circuit (102) against cryptanalysis, in particular against differential power analysis,
by hiding the power consumption profiles of said calculations and
by alternating between different power consumption profiles, in particular by introducing one or more counter signals (51; 61; 71, 81), for example one or more signals of at least roughly opposite amplitude relative to an average amplitude, wherein the sum of the respective amplitude of the one or more original or true signals (50; 60; 70, 80) may be at least roughly balanced out by the sum of the respective amplitude of the one or more counter signals (51; 61; 71, 81) and/or wherein the number of original or true signals (50; 60; 70, 80) is not necessarily equal to the number of counter signals (51; 61; 71, 81), with for example two counter signals (51; 61; 71, 81) on average for every original or true signal (50; 60; 70, 80).

2. The data processing device according to claim 1, characterized by at least one finite state machine (104) or at least one periodical unit for controlling the order of the original or true signals (50; 60; 70, 80) and of the introduced counter signals (51; 61; 71, 81).

3. The data processing device according to claim 2, characterized by at least one non-volatile memory (106) for storing information on at least one suitable state, in particular on the last state or on the current state, of the finite state machine (104) or periodical unit wherein
the non-volatile memory (106) of the suitable state of the finite state machine (104) or of the periodical unit can be kept at power down so that the state after powering up the data processing device (100) is not the same all the time or
that the finite state machine (104) or the periodical unit can be seeded at power up.

4. The data processing device according to claim 3, characterized by at least one sensor (108) of physical characteristics for providing at least one seed value for the finite state machine (104) or for the periodical unit.

5. A method for operating at least one data processing device (100), in particular at least one embedded system, such as at least one smart card, comprising at least one integrated circuit (102) carrying out calculations, in particular cryptographic operations,
characterized in
that the integrated circuit (102) is protected against cryptanalysis, in particular against differential power analysis,
by hiding the power consumption profiles of said calculations and
by alternating between different power consumption profiles, in particular by introducing one or more counter signals (51; 61; 71, 81), for example one or more signals of at least roughly opposite amplitude relative to an average amplitude, wherein the sum of the respective amplitude of the one or more original or true signals (50; 60; 70, 80) may be at least roughly balanced out by the sum of the respective amplitude of the one or more counter signals (51; 61; 71, 81) and/or wherein the number of original or true signals (50; 60; 70, 80) is not necessarily equal to the number of counter signals (51; 61; 71, 81), with for example two counter signals (51; 61; 71, 81) on average for every original or true signal (50; 60; 70, 80).

6. The method according to claim 5, characterized in that the counter signals (51; 61; 71, 81) are produced during different cryptographic calculations and not instantaneously at the moment of the original or true signals (50; 60; 70, 80).

7. The method according to claim 5 or 6, characterized by wiping out the original or true signals (50; 60; 70, 80) when an average over all power traces is taken.

8. The method according to at least one of claims 5 to 7, characterized by being based on
the D[ata]E[ncryption]S[tandard] algorithm,
the A[dvanced]E[ncryption]S[tandard] algorithm,
the R[ivest,]S[hamir and]A[dleman] algorithm,
the E[lliptic]C[urve]C[ryptosystem] algorithm, or
the S[ecure]H[ash]A[lgorithm] algorithm.

9. The method according to at least one of claims 5 to 8, characterized by being driven by at least one periodic signal.

10. Use of at least one data processing device (100) according to at least one of claims 1 to 4 and/or of the method according to at least one of claims 5 to 9 for protecting digital parts of at least one integrated circuit (102), in particular for increasing the security of at least one integrated circuit (102) against unauthorized access, for example via cryptanalysis, in particular via differential power analysis.
